(19) United States
(12) Patent Application Publication
(10) Pub. No.: US 2026/0122569 A1
(43) Pub. Date: Apr. 30, 2026

(54) BANDWIDTH PART-SPECIFIC WAKE UP SIGNALING FOR WIRELESS COMMUNICATIONS

(71) Applicant: QUALCOMM Incorporated, San Diego, CA (US)

(72) Inventors: Diana MAAMARI, San Diego, CA (US); Gabi SARKIS, San Diego, CA (US); Huilin XU, Temecula, CA (US); Sibasish DAS, San Diego, CA (US); Le LIU, San Jose, CA (US); Kangqi LIU, San Diego, CA (US); Weimin DUAN, San Diego, CA (US)

(21) Appl. No.: 18/927,639

(22) Filed: Oct. 25, 2024

(51) Int. Cl. H04W 52/02; H04W 72/044; H04W 76/28

(52) U.S. Cl. CPC H04W 52/0235; H04W 52/0216; H04W 72/044; H04W 76/28

(57) ABSTRACT

Methods, systems, and devices for wireless communications are described. A user equipment (UE) may receive a bandwidth part (BWP) configuration that indicates a set of BWPs configured for communications by the UE. The UE may then receive a wake-up signal (WUS) monitoring configuration that indicates respective monitoring window offset values, respective time gap values, or both, for the set of configured BWPs (e.g., a per-BWP configuration for the monitoring window offset values, respective time gap values, or both). In some aspects, the respective monitoring window offset values and respective time gap values correspond to boundaries of respective WUS monitoring windows for set of configured BWPs. The UE may then monitor, within each BWP of the set of configured BWPs, for wake-up signaling. The UE may monitor for the wake-up signaling during one or more WUS monitoring occasions within the respective WUS monitoring window for the BWP.

### FIELD OF TECHNOLOGY

The following relates to wireless communications, including bandwidth part-specific wake up signaling techniques for wireless communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein. A user equipment (UE) may be configured with a discontinuous reception (DRX) cycle, in which a network entity may configure a set of “ON” durations, in which the UE may actively monitor for downlink communications (such as for wake up signals (WUSs)), and a set of “OFF” durations, in which the UE may remain in a power saving or idle state. In some aspects, the UE may receive a WUS monitoring configuration that indicates different respective monitoring window offset values, different respective time gap values, or both, that defines a monitoring window that the UE may monitor for the WUS during the DRX cycle.

In some implementations, the monitoring window (including the monitoring window offset values, respective time gap values, or both) may be configured per-bandwidth part (BWP) configuration of the UE to increase scheduling flexibility and power saving. For example, the UE may receive a configuration that indicates a set of configured BWPs for the UE, and configured different respective monitoring window offset values, different respective time gap values, or both (e.g., a per-BWP configuration for the monitoring window offset values, respective time gap values, or both). The UE may then monitor, within each BWP of the set of configured BWPs, for wake-up signaling based on the BWP configuration.

A method for wireless communications by UE is described. The method may include receiving a configuration that indicates a set of multiple BWPs configured for communications by the UE, receiving a WUS monitoring configuration that indicates different respective monitoring window offset values, different respective time gap values, or both for the set of multiple BWPs configured for communications by the UE, where the respective monitoring window offset values and respective time gap values correspond to boundaries of different respective WUS monitoring windows for the set of multiple BWPs, and monitoring, within each BWP of the set of multiple BWPs configured for communications by the UE, for wake-up signaling during one or more WUS monitoring occasions within the respective WUS monitoring window for the BWP.

A UE for wireless communications is described. The UE may include one or more memories storing processor executable code, and one or more processors coupled with the one or more memories. The one or more processors may individually or collectively be operable to execute the code to cause the UE to receive a configuration that indicates a set of multiple BWPs configured for communications by the UE, receive a WUS monitoring configuration that indicates different respective monitoring window offset values, different respective time gap values, or both for the set of multiple BWPs configured for communications by the UE, where the respective monitoring window offset values and respective time gap values correspond to boundaries of different respective WUS monitoring windows for the set of multiple BWPs, and monitor, within each BWP of the set of multiple BWPs configured for communications by the UE, for wake-up signaling during one or more WUS monitoring occasions within the respective WUS monitoring window for the BWP.

Another UE for wireless communications is described. The UE may include means for receiving a configuration that indicates a set of multiple BWPs configured for communications by the UE, means for receiving a WUS monitoring configuration that indicates different respective monitoring window offset values, different respective time gap values, or both for the set of multiple BWPs configured for communications by the UE, where the respective monitoring window offset values and respective time gap values correspond to boundaries of different respective WUS monitoring windows for the set of multiple BWPs, and means for monitoring, within each BWP of the set of multiple BWPs configured for communications by the UE, for wake-up signaling during one or more WUS monitoring occasions within the respective WUS monitoring window for the BWP.

A non-transitory computer-readable medium storing code for wireless communications is described. The code may include instructions executable by one or more processors to receive a configuration that indicates a set of multiple BWPs configured for communications by the UE, receive a WUS monitoring configuration that indicates different respective monitoring window offset values, different respective time gap values, or both for the set of multiple BWPs configured for communications by the UE, where the respective monitoring window offset values and respective time gap values correspond to boundaries of different respective WUS monitoring windows for the set of multiple BWPs, and monitor, within each BWP of the set of multiple BWPs configured for communications by the UE, for wake-up signaling during one or more WUS monitoring occasions within the respective WUS monitoring window for the BWP.

In some examples of the method, UEs, and non-transitory computer-readable medium described herein, a respective time gap value for a BWP included in the set of multiple BWPs includes a first time offset relative to a beginning of an ON duration of a DRX cycle for the BWP, a respective monitoring window offset value for the BWP includes a second time offset relative to the beginning of the ON duration of the DRX cycle for the BWP, and a respective WUS monitoring window for the BWP begins at a first time corresponding to the first time offset and ends at a second time corresponding to the second time offset.

In some examples of the method, UEs, and non-transitory computer-readable medium described herein, a first monitoring window offset value and a first time gap value for a first BWP of the set of multiple BWPs and a second monitoring window offset value and a second time gap value for a second BWP of the set of multiple BWPs, where the second monitoring window offset value may be different than the first monitoring window offset value, the second time gap value may be different than the first time gap value, or both.

In some examples of the method, UEs, and non-transitory computer-readable medium described herein, the first BWP may be a first type of BWP and the second BWP may be a second type of BWP associated with higher power usage, higher throughput, lower latency, or any combination thereof relative to the first type of BWP, the first monitoring window offset value, the first time gap value, or both may be associated with the first type of BWP, and the second monitoring window offset value, the second time gap value, or both may be associated with the second type of BWP.

Some examples of the method, UEs, and non-transitory computer-readable medium described herein may further include operations, features, means, or instructions for transmitting a message that indicates a requested monitoring window offset value, a requested time gap value, or both for at least one BWP of the set of multiple BWPs configured for communications by the UE.

In some examples of the method, UEs, and non-transitory computer-readable medium described herein, the message includes a UE assistance information message, a medium access control-control element (MAC-CE), an uplink control information message, or a UE capability message.

In some examples of the method, UEs, and non-transitory computer-readable medium described herein, the at least one BWP includes a first BWP of a first BWP type and a second BWP of a second BWP type associated with higher power usage, higher throughput, lower latency, or any combination thereof relative to the first BWP type and the message indicates a first requested monitoring window offset value and a first requested time gap value corresponding to the first BWP type and a second requested monitoring window offset value and a second requested time gap value corresponding to the second BWP type.

In some examples of the method, UEs, and non-transitory computer-readable medium described herein, the set of multiple BWPs includes a first BWP and a second BWP and the method, apparatuses, and non-transitory computer-readable medium may include further operations, features, means, or instructions for initiating, prior to an ON duration of a first DRX cycle for the first BWP, a first WUS monitoring window for the UE in accordance with a first monitoring window offset value associated with the first BWP, switching, after the ON duration of the first DRX cycle for the first BWP, from monitoring the first BWP to monitoring the second BWP, and initiating, prior to an ON duration of a second DRX cycle for the second BWP, a second WUS monitoring window for the UE in accordance with a second monitoring window offset value associated with the second BWP, where initiation of the first WUS monitoring window precedes the ON duration of the first DRX cycle for the first BWP by a first time duration and initiation of the second WUS monitoring window precedes the ON duration of the second DRX cycle for the second BWP by a second time duration that may be different than the first time duration in accordance with the second monitoring window offset value being different than the first monitoring window offset value.

In some examples of the method, UEs, and non-transitory computer-readable medium described herein, conclusion of the first WUS monitoring window precedes the ON duration of the first DRX cycle for the first BWP by a third time duration and conclusion of the second WUS monitoring window precedes the ON duration of the second DRX cycle for the second BWP by a fourth time duration that may be different than the third time duration in accordance with a second time gap value associated with the second BWP being different than a first time gap value associated with the first BWP.

In some examples of the method, UEs, and non-transitory computer-readable medium described herein, the first WUS monitoring window may be associated with a first energy expenditure by the UE that may be different than a second energy expenditure by the UE associated with the second WUS monitoring window.

Some examples of the method, UEs, and non-transitory computer-readable medium described herein may further include operations, features, means, or instructions for receiving, from a network entity, an indication of a respective range of allowed monitoring window offset values, a respective range of allowed time gap values, or both for each BWP of the set of multiple BWPs and transmitting a message that indicates a requested monitoring window offset value, a requested time gap value, or both for at least one BWP of the set of multiple BWPs configured for communications by the UE, where the requested monitoring window offset value falls within the respective range of allowed monitoring window offset values for the at least one BWP, the requested time gap value falls within the respective range of allowed time gap values for the at least one BWP, or both.

In some examples of the method, UEs, and non-transitory computer-readable medium described herein, the indication of the respective range of allowed monitoring window offset values includes an indication of a maximum allowable time offset relative to a default time gap value.

In some examples of the method, UEs, and non-transitory computer-readable medium described herein, receiving the WUS monitoring configuration may include operations, features, means, or instructions for receiving the WUS monitoring configuration via radio resource control (RRC) configuration signaling.

In some examples of the method, UEs, and non-transitory computer-readable medium described herein, the respective time gap values for the set of multiple BWPs include respective first time offsets relative to respective ON durations of respective DRX cycles for the set of multiple BWPs, at least two BWPs of the set of multiple BWPs associated with different respective time gap values and the respective monitoring window offset values for the set of multiple BWPs include respective second time offsets relative to the respective time gap values, at least two BWPs of the set of multiple BWPs associated with identical respective time gap values.

Some examples of the method, UEs, and non-transitory computer-readable medium described herein may further include operations, features, means, or instructions for monitoring for the wake-up signaling within a BWP of the set of multiple BWPs includes monitoring, using a low-power radio, for one or more low-power WUSs during the one or more WUS monitoring occasions within the respective WUS monitoring window for the BWP and the method further includes activating, at the UE, a main radio in accordance with detection of at least one of the one or more low-power WUSs.

In some examples of the method, UEs, and non-transitory computer-readable medium described herein, the one or more low-power WUSs include on-off keying (OOK) modulated symbols of an orthogonal frequency division multiplexed (OFDM) waveform.

In some examples of the method, UEs, and non-transitory computer-readable medium described herein, the WUS monitoring configuration indicating the respective monitoring window offset values and the respective time gap values may be associated with a traffic type associated with the UE, one or more capabilities of the UE, or both.

In some examples of the method, UEs, and non-transitory computer-readable medium described herein, the wake-up signaling includes downlink control information (DCI) signaling having a DCI format that may be specific to the wake-up signaling.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIGS. 1 and 2 show examples of wireless communications systems that support bandwidth part (BWP)-specific wake up signaling techniques for wireless communications in accordance with one or more aspects of the present disclosure.

FIG. 3 shows examples of BWP-specific wake up signal (WUS) monitoring configurations that support BWP-specific wake up signaling techniques for wireless communications in accordance with one or more aspects of the present disclosure.

FIG. 4 shows an example of a process flow that supports BWP-specific wake up signaling techniques for wireless communications in accordance with one or more aspects of the present disclosure.

FIGS. 5 and 6 show block diagrams of devices that support BWP-specific wake up signaling techniques for wireless communications in accordance with one or more aspects of the present disclosure.

FIG. 7 shows a block diagram of a communications manager that supports BWP-specific wake up signaling techniques for wireless communications in accordance with one or more aspects of the present disclosure.

FIG. 8 shows a diagram of a system including a device that supports BWP-specific wake up signaling techniques for wireless communications in accordance with one or more aspects of the present disclosure.

FIGS. 9 and 10 show flowcharts illustrating methods that support BWP-specific wake up signaling techniques for wireless communications in accordance with one or more aspects of the present disclosure.

### DETAILED DESCRIPTION

A user equipment (UE) may be configured with connected mode discontinuous reception (C-DRX) cycle for periodic monitoring a wireless medium for downlink communications. In some aspects, a DRX cycle (having configured ON and OFF durations) may allow the UE to reduce power consumption and extend battery life by allowing the UE to periodically enter a ‘sleep’ state (e.g., during an OFF duration of the C-DRX cycle) during which the UE does not monitor for downlink communications, and does not transmit uplink communications. The UE may then periodically wake up to monitor for possible downlink data (or to transmit uplink data) during an ‘active’ state (e.g., an ON duration of the C-DRX cycle).

To further increase energy savings, the UE may support wake-up signal (WUS) monitoring. For example, a WUS may be a low power, low complexity signal (such as a downlink control information (DCI) message) that the UE may monitor for using a wake up radio. If the UE detects a WUS during a WUS monitoring occasion, then the UE may fully wake up from a power saving mode to receive communications. In some implementations, the UE may be configured with a set of WUS monitoring occasions associated with a DRX cycle, where each WUS monitoring occasion occurs outside of (and prior to) respective ON durations of a DRX cycle. The UE may use each WUS monitoring occasion to monitor for a WUS, and may wake up for the subsequent ON duration of the DRX cycle and start a DRX ON duration timer (e.g., drx-onDurationTimer) if the UE detects a WUS.

The UE may monitor for the WUS during monitoring occasions which start at or after an offset (e.g., ps_Offset) and ending before a slot that the drx-onDurationTimer is configured to start. A minimum time gap may be configured as the duration before the slot that the drx-onDurationTimer is configured to start, and is a duration within which the UE may not monitor for the WUS. The UE may monitor discrete monitoring occasions (e.g., WUS monitoring occasions) located within ps_Offset and the minimum time gap, with time between ps_Offset and the minimum time gap defining a window within a monitoring occasion that the UE may monitor for a WUS.

In some cases, a network entity may configure the ps_Offset and the minimum time gap (e.g., configuration of the WUS monitoring window) on a per-UE basis, based on UE capability. In at least some examples, however, such per-UE configuration may alternatively be configured per bandwidth part (BWP) configuration for the UE. For example, for low latency critical traffic, the network entity may configure the with a BWP that supports a shorter wakeup timeline (e.g., a full BWP), so that the UE can quickly detect the WUS, wake up, and receive the latency critical traffic. In some other implementations, for example, for other traffic that is not latency-sensitive (or otherwise lower priority traffic), the network entity may configure the UE with a BWP that supports a longer wakeup timeline (e.g., a power saving BWP) so that the UE can utilize a relatively longer duration to receive the WUS, wake up, and receive the lower priority traffic. In cases that the UE receives an earlier indication to wake up, the UE may utilize a longer duration to wake up, which conserves more energy relative to if the UE receives a later indication to wake up (e.g., a shorter or faster wake up may cost more energy than a longer wake up).

The per-BWP configuration of the ps_Offset and the minimum time gap (and configuration of the monitoring window that the UE uses to monitor for the WUS) may allow the UE to more realize power saving gains by configuring the UE to utilize different wake up timings per configured BWP. In addition, the network entity may have more dynamic control of how the UE monitors for the WUS, and may direct the UE to switch between full power and power saving modes based on BWP switching.

Aspects of the disclosure may be implemented to realize one or more of the following potential advantages. Configuring the ps_Offset and the minimum time gap per BWP (e.g., where he ps_Offset and the minimum time gap may be different for different BWP configurations) may allow for increased power saving gains for the UE, since the network may dynamically control how slow or fast the UE wakes up to receive wake up signaling based on different BWP types, based on different traffic types or both. For example, for a low latency high throughput BWP, the UE may be configured to wake up relatively quickly (expending relatively more energy), and then may switch to a power saving BWP where the UE may be configured to wake up relatively slowly (expending relatively less energy). Additionally, or alternatively, the techniques described herein may allow for reduced signaling overhead since the configuration of ps_Offset and the minimum time gap may be included in an existing BWP configuration, eliminating the need for additional or supplemental signaling.

Aspects of the disclosure are initially described in the context of wireless communications systems. Aspects of the disclosure are further illustrated by and described with reference to BWP-specific WUS monitoring configurations, a process flow, apparatus diagrams, system diagrams, and flowcharts that relate to BWP-specific wake up signaling techniques for wireless communications.

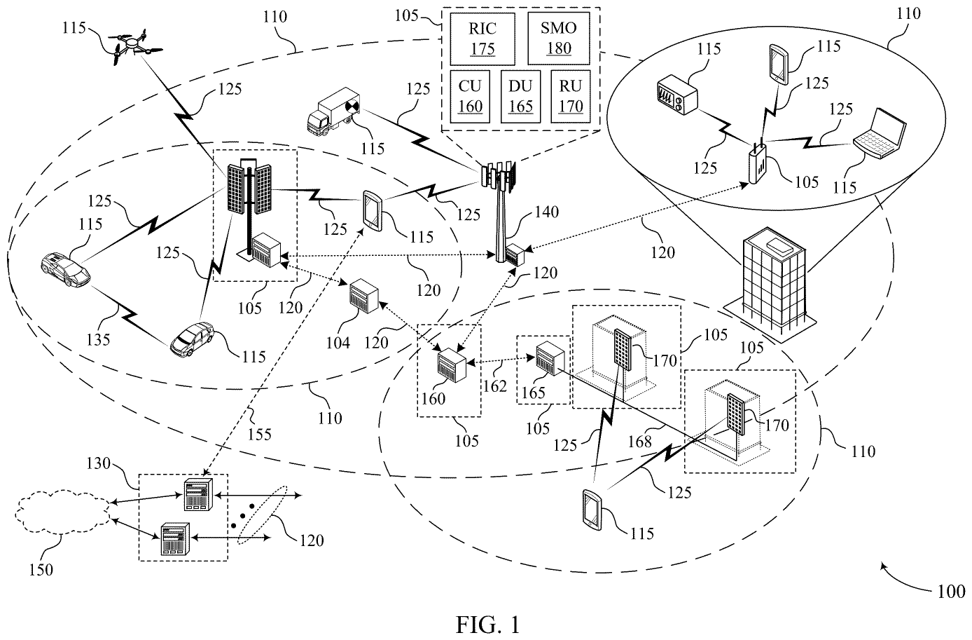

FIG. 1 shows an example of a wireless communications system 100 that supports BWP-specific wake up signaling techniques for wireless communications in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support BWP-specific wake up signaling techniques for wireless communications as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a BWP) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

A carrier may be associated with a particular bandwidth of the RF spectrum, and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 may configure a UE 115 with one or more BWPs to use for communication. A BWP may be a frequency range or a set of frequency resources (e.g., a configured set of frequency resources with a defined span or range within a frequency domain, which may be a portion of a channel bandwidth of a network entity 105). For example, a BWP may include a contiguous set of physical resource blocks (PRBs) on a given carrier, where each PRB is selected from a contiguous subset of the common resource blocks for a given numerology. The UE 115 may receive and transmit both control information and data within a frequency range of an active BWP, and may switch between different configured BWPs based on dedicated signaling from the network. In some cases, a network entity 105 may create different set of configuration parameters (such as maximum scheduling bandwidth, maximum rank, maximum modulation order based on configured MCS table values, and other parameters) that relate to downlink reception and uplink transmission. The network entity 105 may then instruct the UE 115 to switch between different configuration parameters using BWP switching without RRC reconfiguration.

In some implementations, the UE 115 may be configured with different BWP types, such as full BWPs or power saving BWPs. A power saving BWP may be configured to support power savings by the UE 115 relative to a full BWP based on different configurations with respect to the frequency domain, the time domain, or both. For example, a full BWP may span a larger portion of the channel bandwidth (e.g., span a larger frequency range) relative to a power-saving BWP, and thus a full BWP may be larger in the frequency domain compared to a power saving BWP. Additionally or alternatively, a power saving BWP may be configured for intermittent (e.g., discontinuous) and relatively sparse (in the time domain) monitoring by the UE 115 for physical downlink control channel (PDCCH) messages, whereas a full BWP may be configured for continuous or relative dense (in the time domain) PDCCH monitoring by the UE 115. A power saving BWP that is configured for intermittent and relatively sparse PDCCH monitoring in the time domain may be referred to as a sparse BWP.

In some examples, a UE 115 may be configured with both a full BWP and a power saving BWP, and the UE 115 may switch between the two BWPs based on DCI indication from the network, based on expiration of a timer, based on RRC configuration (or reconfiguration), or based on traffic conditions. In some cases, for example during times of low relative network traffic, the UE 115 may save power by switching to a power saving BWP, which may allow the UE 115 to monitor a smaller total bandwidth. During times of higher relative network traffic, the UE 115 may switch to a full BWP in order to accommodate higher data rates or low latency and high reliability traffic.

A UE 115 may be configured with a DRX configuration for periodic monitoring for downlink communications. In some aspects, a DRX cycle (having configured ON and OFF durations) may allow the UE 115 to reduce power consumption and extend battery life by allowing the UE to periodically enter a ‘sleep’ state (e.g., an OFF duration of the DRX cycle), and then periodically wake up during an ‘active’ state (e.g., an ON duration of the DRX cycle).

The UE 115 may also support WUS monitoring to increase power savings. For example, if the UE 115 detects a WUS during a WUS monitoring occasion, then the UE 115 may fully wake up from a power saving mode to receive communications, otherwise the UE 115 may remain in a power saving state. In some implementations, the UE 115 may be configured with a set of WUS monitoring occasions associated with a DRX cycle, where each WUS monitoring occasion occurs outside of (and prior to) respective ON durations of a DRX cycle. The UE 115 may use each WUS monitoring occasion to monitor for a WUS, and may wake up for the subsequent ON duration of the DRX cycle and start a DRX ON duration timer (e.g., drx-onDurationTimer) if the UE 115 detects a WUS.

The UE 115 may monitor for the WUS in monitoring occasions starting at or after an offset (e.g., ps_Offset) and ending before a slot that the drx-onDurationTimer is configured to start. A minimum time gap may be configured as the duration before the slot that the drx-onDurationTimer is configured to start, and is a duration within which the UE may not monitor for the WUS. The UE 115 may monitor discrete monitoring occasions (e.g., WUS monitoring occasions) located within ps_Offset and the minimum time gap, with time between ps_Offset and the minimum time gap defining a window within a monitoring occasion that the UE 115 may monitor for a WUS.

In some cases, a network entity 105 may configure the ps_Offset and the minimum time gap (e.g., configuration of the WUS monitoring window) on a per-UE basis. In at least some examples, however, such per-UE configuration may alternatively be configured per-BWP configuration for the UE 115. For example, for low latency critical traffic, the network entity 105 may configure the with a BWP that supports a shorter wakeup timeline (e.g., a full BWP), so that the UE 115 can quickly detect the WUS, wake up, and receive the latency critical traffic. In some other implementations, for example, for other traffic that is not latency-sensitive (or otherwise lower priority traffic), the network entity 105 may configure the UE 115 with a BWP that supports a longer wakeup timeline (e.g., a power saving BWP) so that the UE 115 can take a relatively longer duration to receive the WUS, wake up, and receive the lower priority traffic. In cases that the UE 115 receives an earlier indication to wake up, the UE 115 may take longer to wake up, which conserves more energy relative to if the UE 115 receives a later indication to wake up (e.g., a shorter or faster wake up may cost more energy than a longer wake up).

The per-BWP configuration of the ps_Offset and the minimum time gap (and configuration of the monitoring window that the UE uses to monitor for the WUS) may allow the UE 115 to more realize power saving gains by configuring the UE to utilize different wake up timings per configured BWP. In addition, the network entity may have more dynamic control of how the UE 115 monitors for the WUS.

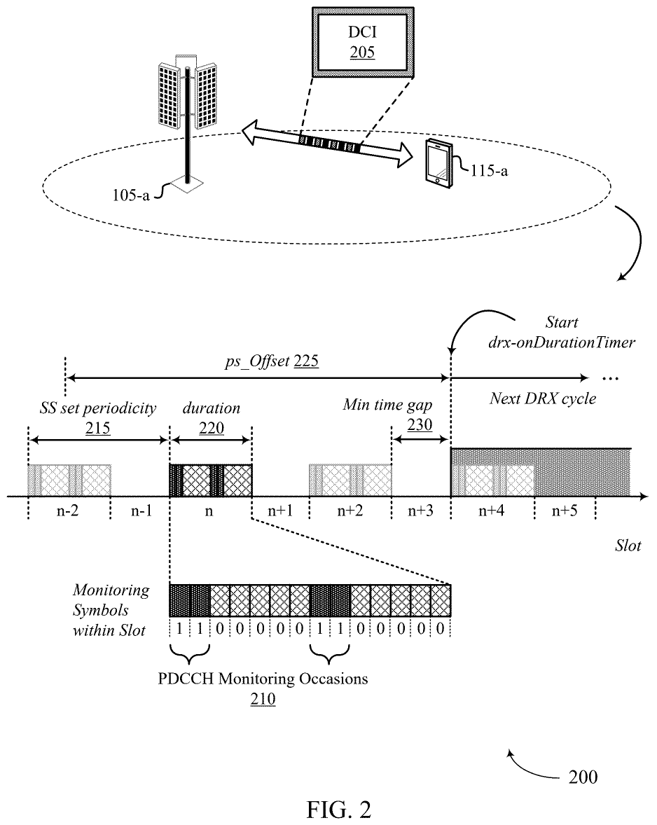

FIG. 2 shows an example of a wireless communications system 200 that supports BWP-specific wake up signaling techniques for wireless communications in accordance with one or more aspects of the present disclosure. For example, the wireless communications system 200 may support communications between a UE 115-a and a network entity 105-a, each of which may be examples of UEs 115 and network entities 105 described with reference to FIG. 1.

The UE 115-a may be configured with connected mode DRX (C-DRX), which may allow for reduced power consumption by allowing the UE 115-a to periodically enter a ‘sleep’ state (e.g., during an OFF duration of the C-DRX cycle) during which the UE 115-a does not monitor the PDCCH. The UE 115-a may periodically wake up to monitor the PDCCH for possible downlink data (or to transmit uplink data) during an ‘active’ state (e.g., an ON duration of the C-DRX cycle). The UE 115-a may stay awake for a configured duration before going to ‘sleep’ again during an OFF duration.

To further increase energy savings, the UE 115-a may support WUS monitoring (e.g., monitoring for a DCI 205 such as a DCI format 2_6) in addition to a DRX configuration. For example, the UE 115-a may be configured with a set of WUS monitoring occasions with each DRX cycle, where each WUS monitoring occasion occurs outside of (and prior to) respective ON durations of a DRX cycle. The UE 115-a may then use each WUS monitoring occasion to monitor for a WUS, and if the UE 115-a detects a WUS, then the UE 115-a may wake up for the subsequent ON duration of the DRX cycle and start a DRX ON duration timer (e.g., drx-onDurationTimer). If the UE 115-a does not detect a WUS within a preceding WUS monitoring occasion, then the UE 115-a may remain in a power saving or idle mode during the subsequent ON duration of the DRX cycle, and may not start the DRX ON duration timer.

The UE 115-a may be configured with a set of WUS monitoring occasions (e.g., PDCCH monitoring occasions 210), where the UE 115-a may monitor for the DCI 205 (e.g., a DCI format 2_6 or other WUS-specific DCI), in accordance with a search space periodicity 215. For each search space set configured for monitoring for the DCI 205, the UE 115-a may monitor PDCCH occasions in a first duration (e.g., duration 220) starting at or after an offset (e.g., ps_Offset 225, having values ∈{0.125 ms, 0.25 ms, 0.375 ms, . . . , 15 ms}) and ending before a slot that the drx-onDurationTimer is configured to start (e.g., after completion of slot n+3). The minimum time gap 230 may be configured as the duration before the slot that the drx-onDurationTimer is configured to start, and is a duration within which the UE 115-a may not monitor for the DCI 205 (e.g., the WUS). In such implementations, the UE 115-a may monitor discrete monitoring occasions (e.g., WUS monitoring occasions) located within ps_Offset 225 and the minimum time gap 230, and the time between ps_Offset 225 and the minimum time gap 230 define a window within the PDCCH occasion that the UE 115-a uses to monitor for a WUS. In some examples, the minimum time gap 230 may be based on UE capabilities, and may be configured as a quantity of slots. For example, the UE 115-a may, for each subcarrier spacing supported by the UE 115-a, report one value for the minimum time gap 230 from a set of at least two candidate values. In some aspects, the set of at least two candidate values may include various values (within a value range that has a maximum of 3 milliseconds).

In some cases, the network entity 105-a may configure the ps_Offset 225 and the minimum time gap 230 on a per-UE basis (e.g., based on UE capability). In at least some examples, however, configuration of the ps_Offset 225 and the minimum time gap 230 (and configuration of the monitoring window that the UE 115-a uses to monitor for the WUS) may alternatively be configured per BWP configuration for the UE 115-a. For example, for low latency critical traffic, the network entity 105-a may configure the UE 115-a with a BWP that supports a shorter wakeup timeline (e.g., a full BWP), so that the UE 115-a can quickly detect the WUS, wake up, and receive the latency critical traffic. In some other implementations, for example, for other traffic that is not latency-sensitive (or otherwise lower priority traffic), the network entity 105-a may configure the UE 115-a with a BWP that supports a longer wakeup timeline (e.g., a power saving BWP) so that the UE 115-a can take a relatively longer duration to receive the WUS, wake up, and receive the lower priority traffic. In cases that the UE 115-a receives an earlier indication to wake up, the UE 115-a may take longer to wake up, which conserves more energy relative to if the UE 115-a receives a later indication to wake up (e.g., a shorter or faster wake up may cost more energy than a longer wake up). The per-BWP configuration of the ps_Offset 225 and the minimum time gap 230 (and configuration of the monitoring window that the UE 115-a uses to monitor for the WUS) may allow the UE 115-a to more realize power saving gains by configuring the UE 115-a to utilize different wake up timings per configured BWP and based on different types of traffic, and allowing for the changing or modification of the wake up timings based on a BWP switching mechanism. Additionally, or alternatively, along with the BWP-based configuration, ps_Offset 225 and the minimum time gap 230 may be configured based on traffic type (e.g., low latency traffic, high priority traffic, or other traffic types such as extended reality (XR) traffic or other traffic having a target quality of service), based on various capabilities of the UE 115-b, or both.

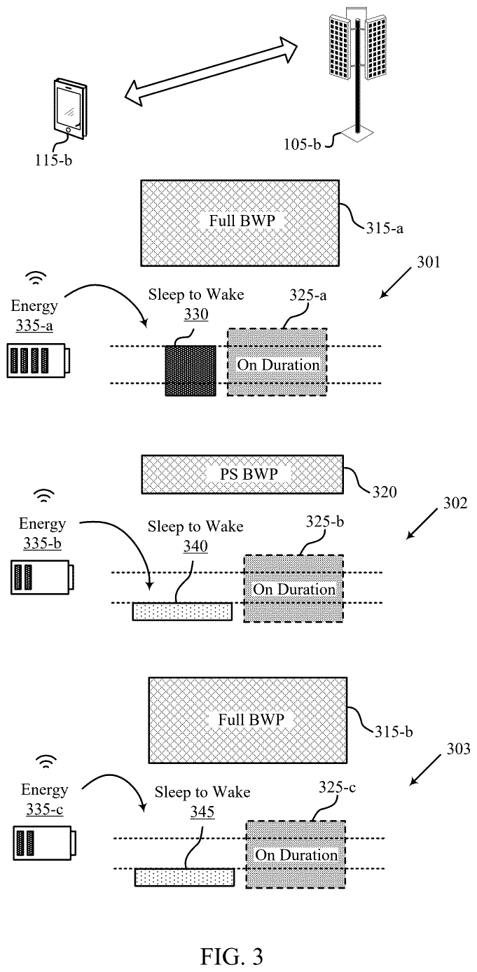

FIG. 3 show examples of BWP-specific WUS monitoring configurations 301, 302, and 303 that support BWP-specific wake up signaling techniques for wireless communications in accordance with one or more aspects of the present disclosure. For example, the BWP-specific WUS monitoring configurations 301, 302, and 303 may be implemented at or by a UE 115-b and a network entity 105-b, each of which may be examples of UEs 115 and network entities 105 described with reference to FIGS. 1 and 2.

The UE 115-b may be configured with a monitoring window to monitor for a PDCCH carrying a WUS (e.g., a DCI 2_6, or otherwise a DCI of power saving) per BWP configured for the UE 115-b. The UE 115-b may be configured with a set of WUS monitoring occasions (e.g., PDCCH monitoring occasions), where the UE 115-b may monitor for the DCI. For each search space set configured for monitoring for the DCI 205, the UE 115-a may monitor PDCCH occasions in a first duration (e.g., duration) starting at or after an offset (e.g., ps_Offset) and ending before a slot that the DRX timer is configured to start. The minimum time gap may be configured as the time duration before the slot that the drx-onDurationTimer is configured to start, and is a duration within which the UE 115-b may not monitor for the WUS. In such implementations, the UE 115-b may monitor discrete monitoring occasions (e.g., WUS monitoring occasions) located within ps_Offset and the minimum time gap, and the time between ps_Offset and the minimum time gap define the monitoring window that the UE 115-b may use to monitor for the WUS. In some examples, the monitoring window, including the parameters of ps_Offset and the minimum time gap, may be configured per BWP, which may enhance power savings and scheduling flexibility for the UE 115-b.

In some implementations, the network entity 105-b may configure, for the UE 115-b, at least one or more values for ps_Offset and the minimum time gap (and thus, one or more different monitoring windows) per BWP configuration for the UE. For example, in BWP-specific WUS monitoring configuration 301, the UE 115-b may be configured with a full BWP 315-a, and may be configured with a ps_Offset value T1 and minimum time gap value T1′, which may be configured based on the full BWP 315-a. For example, the full BWP 315-a may be a low latency BWP, a high throughput BWP, a high priority communications BWP, a BWP serving XR traffic or other high performance services, or any combination thereof, having a first ON duration 325-a. The network entity 105-b may configure the ps_Offset value T1 and minimum time gap value T1′ so that the UE 115-b has a relatively shorter sleep to wake period 330 (utilizing a greater amount of battery power 335-a), allowing the UE 115-b to quickly transition from a power saving state to an active state in order to receive communications within the low latency BWP.

In BWP-specific WUS monitoring configuration 302, the UE 115-b may be configured with a power saving BWP 320, and may be configured with a ps_Offset value T2 and minimum time gap value T2′, which may be configured based on the power saving BWP 320. For example, the power saving BWP 320 may be a relatively lower latency communications BWP (e.g., for non-critical or non-latency sensitive traffic) with a first ON duration 325-b, and the network entity 105-b may configure the ps_Offset value T2 and minimum time gap value T2′ so that the UE 115-b has a relatively longer sleep to wake period 340 (utilizing relatively less battery power 335-b). The relatively longer sleep to wake period 340 may allow the UE 115-b to gradually transition from a power saving state to an active state (conserving power) in order to receive communications in the power saving BWP 320.

In BWP-specific WUS monitoring configuration 303, the UE 115-b may be configured with a full BWP 315-b, and may be configured with a ps_Offset value T3 and minimum time gap value T3′, which may be configured based on the full BWP 315-b. For example, the full BWP 315-b may be a high throughput BWP (e.g., not necessarily low latency) with a first ON duration 325-c. The network entity 105-b may configure the ps_Offset value T3 and minimum time gap value T3′ so that the UE 115-b has a relatively longer sleep to wake period 345 (utilizing relatively less battery power 335-c). The relatively longer sleep to wake period 345 may allow the UE 115-b to gradually transition from a power saving state to an active state (conserving power) in order to receive communications in the full BWP 315-b.

In some implementations, the UE 115-b may transmit an assistance information message (e.g., via uplink control information, MAC-CE, UE assistance signaling, a UE capability message, or other uplink control signaling) a set of recommended values for the ps_Offset, the minimum time gap, the WUS monitoring window, or any combination thereof, to the network entity 105-b. For example, for the full BWP 315-a, the UE 115-b may indicate or suggest a ps_Offset value T1 and minimum time gap value T1′ (or a set of multiple values) based on a desired performance of the UE 115-b, or a capability of the UE 115-b. Additionally, or alternatively, the UE 115-b may indicate or suggest a ps_Offset value T2 and minimum time gap value T2′ (or a set of multiple values) based on a desired performance of the UE 115-b, or a capability of the UE 115-b in the power saving BWP 320. Additionally, or alternatively, the UE 115-b may indicate or suggest a ps_Offset value T3 and minimum time gap value T3′ (or a set of multiple values) based on a desired performance of the UE 115-b, or a capability of the UE 115-b in the full BWP 315-a. In some aspects, the UE 115-b may indicate various recommended values of ps_Offset and the minimum time gap to the network entity 105-b, and the network entity 105-b may use the recommended values in order to provide configured values of ps_Offset and the minimum time gap per BWP configuration of the UE 115-b.

In some implementations, the network entity 105-b may transmit WUSs based on network traffic arrival, network traffic predictions, jitter, among other parameters or network conditions. In order to accommodate different network conditions, in some examples the network entity 105-b may configure and indicate a range of values for ps_Offset and the minimum time gap, and the UE 115-b may select desired values for ps_Offset and the minimum time gap within the network-indicated range. In some examples, the range of values may be a set of configured values bounded by respective minimum values of ps_Offset and the minimum time gap and respective maximum values of ps_Offset and the minimum time gap. In some other examples, the network entity 105-b may configure (e.g., via RRC configuration) a maximum negative offset relative to a default minimum time gap. For example, the maximum negative offset may mark the earliest time that the network entity 105-a may transmit the WUS to the UE 115-b.

In some implementations, the ps-Offset may be configured per BWP configuration of the UE 115-b, or the ps-Offset may be configured using the minimum time gap as reference. For example, the ps-Offset may be configured with respect to the end of the WUS monitoring window, which may be determined or configured by the minimum time gap.

In some aspects, the techniques described herein may support sequence-based WUS signaling (e.g., low-power WUS signaling) as well as other WUS signaling. For example, the UE 115-b may monitor for one or more configured WUS sequences (e.g., on-off keying (OOK) generated with OFDM overlaid sequence) using a low power wake up radio at the UE 115-b, while operating in an RRC idle state, and RRC inactive state, an RRC active state (or other RRC connected states). If the low power wake up radio detects the one or more sequences configured for the WUS, the low power wake up radio may wake up the main radio (e.g., the main modem) of the UE 115-b. In some aspects the WUS may be a paging early indication, a WUS (e.g., a group-based DCI or a group-common DCI) or a low-power WUS (e.g., a sequence-based WUS).

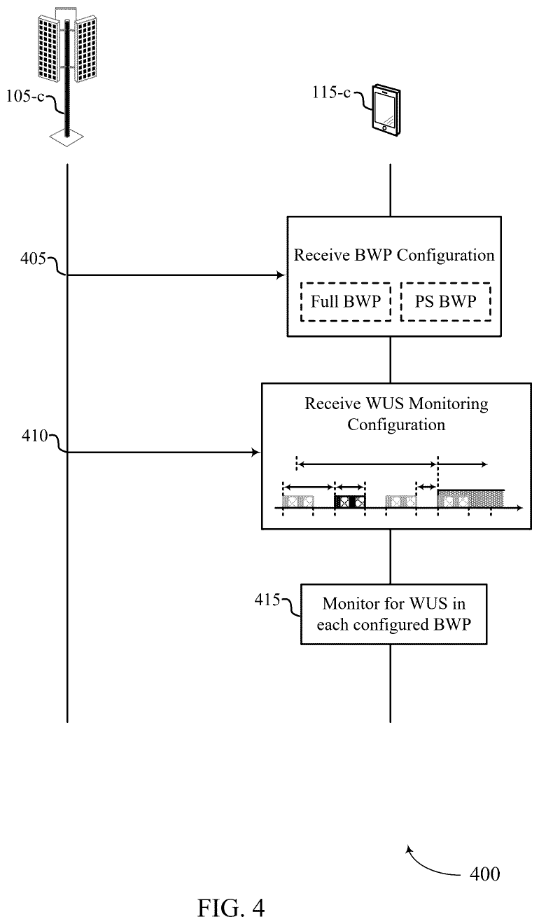

FIG. 4 shows an example of a process flow 400 that supports BWP-specific wake up signaling techniques for wireless communications in accordance with one or more aspects of the present disclosure. In some examples, process flow 400 may implement aspects of, or be implemented by aspects of, the wireless communications system 100, the wireless communications system 200, or the BWP-specific WUS monitoring configurations 301, 302, and 303. For example, the process flow 400 may include a UE 115-c and a network entity 105-c which may be examples of corresponding devices described with reference to FIGS. 1-3.

In the following description of the process flow 400, the operations between the network entity 105-c and the UE 115-c may be performed in different orders or at different times than the example shown. Some operations may also be omitted from the process flow 400, and other operations may be added to the process flow 400. In this example, the network entity 105-c and the UE 115-c may support BWP-specific configuration for WUS monitoring and power saving.

At 405, the UE 115-c may receive a configuration that indicates a set of BWPs configured for communications by the UE 115-c.

At 410, the UE 115-c may receive a WUS monitoring configuration (e.g., via RRC signaling or other control signaling) that indicates different respective monitoring window offset values, different respective time gap values, or both for the set of configured BWPs (e.g., where the WUS monitoring configuration may be based on a traffic type associated with the UE 115-c, one or more capabilities of the UE 115-c, or both). The respective monitoring window offset values and respective time gap values may correspond to boundaries of different respective WUS monitoring windows for the set of BWPs. In some implementations, the UE 115-c may transmit a message (e.g., an uplink control information message, a UE assistance information message, a MAC-CE, a UE capability message, or other control signaling) that indicates a requested monitoring window offset value, a requested time gap value, or both for at least one BWP of the set of configured BWPs. In some aspects, the message indicates a first requested monitoring window offset value and a first requested time gap value corresponding to a first configured BWP type and a second requested monitoring window offset value and a second requested time gap value corresponding to a second configured BWP type (e.g., a BWP type that is associated with higher power usage, higher throughput, lower latency, or any combination thereof relative to the first BWP type)

In some implementations, the UE 115-c may receive, from the network entity 105-c, an indication of a respective range of allowed monitoring window offset values, a respective range of allowed time gap values, or both for each BWP of the configured set of BWPs. For example, the indication of the respective range of allowed monitoring window offset values may be an indication of a maximum allowable time offset relative to a default time gap value. The UE 115-c may transmit a message in response that indicates a requested monitoring window offset value, a requested time gap value, or both for at least one BWP of the configured set of BWPs. In some examples, the requested monitoring window offset value falls within the respective range of allowed monitoring window offset values for the at least one BWP, the requested time gap value falls within the respective range of allowed time gap values for the at least one BWP, or both.

At 415, the UE 115-c may monitor, within each BWP of the set of configured BWPs for wake-up signaling (e.g., one or more WUSs) during one or more WUS monitoring occasions within the respective WUS monitoring window for the BWP. For example, the UE 115-c may monitor for the wake-up signaling within a BWP of the configured set of BWPs using a low-power radio (e.g., a wake-up radio), for one or more low-power WUSs (e.g., WUSs that include on-off keying (OOK) modulated symbols of an OFDM waveform) during the one or more WUS monitoring occasions within the respective WUS monitoring window for the BWP. The UE 115-c may activate a main radio if the low-power radio detects at least one of the one or more low-power WUSs. In some aspects, the WUS may include a DCI message (e.g., a DCI format 2_6, or other WUS-specific DCI signaling).

In some examples, a respective time gap value for a BWP included in the set of configured BWPs includes a first time offset relative to a beginning of an ON duration of a DRX cycle for the BWP. In some examples, a respective monitoring window offset value for the BWP includes a second time offset relative to the beginning of the ON duration of the DRX cycle for the BWP. In some examples, a respective WUS monitoring window for the BWP begins at a first time corresponding to the first time offset and ends at a second time corresponding to the second time offset.

In some examples, the WUS monitoring configuration indicates a first monitoring window offset value and a first time gap value for a first BWP of the set of configured BWPs. Additionally, or alternatively, the WUS monitoring configuration indicates a second monitoring window offset value and a second time gap value for a second BWP of the set of configured BWPs, where the second monitoring window offset value may be different than the first monitoring window offset value, the second time gap value may be different than the first time gap value, or both.

In some examples, the first BWP is a first type of BWP, and the second BWP is a second type of BWP associated with higher usage, higher throughput, lower latency, or any combination thereof relative to the first type of BWP. In some aspects, the first monitoring window offset value, the first time gap value, or both, may be associated with the first type of BWP, and the second monitoring window offset value, the second time gap value, or both, may be associated with the second type of BWP.

In some examples, the configured set of BWPs include a first BWP and a second BWP, and the UE 115-c may initiate, prior to an ON duration of a first DRX cycle for the first BWP, a first WUS monitoring window (associated with a first energy expenditure by the UE 115-c) for the UE 115-c in accordance with a first monitoring window offset value associated with the first BWP. The UE 115-c may then switch, after completion of the ON duration of the first DRX cycle, from monitoring the first BWP to monitoring the second BWP. The UE may then initiate, prior to an ON duration of a second DRX cycle for the second BWP, a second WUS monitoring window (associated with a second energy expenditure by the UE 115-c) for the UE 115-c in accordance with a second monitoring window offset value associated with the second BWP. In some aspects, the initiation of the first WUS monitoring window precedes the ON duration of the first DRX cycle for the first BWP by a first time duration, and initiation of the second WUS monitoring window precedes the ON duration of the second DRX cycle for the second BWP by a second time duration. In some cases, the first time duration may be different from the second time duration based on the second monitoring window offset value being different than the first monitoring window offset value.

In some aspects, conclusion of the first WUS monitoring window may occur prior to the ON duration of the first DRX cycle for the first BWP by a third time duration, and the conclusion of the second WUS monitoring window may occur prior to the ON duration of the second DRX cycle for the second BWP by a fourth time duration. In some such cases, the fourth time duration may be different from the third time duration based on a second time gap value associated with the second BWP being different from a first time gap value associated with the first BWP.

In some examples, the respective time gap values for the configured set of BWPs include first time offsets relative to respective ON durations of respective discontinuous reception cycles for the plurality of BWPs, at least two BWPs of the configured set of BWPs associated with different respective time gap values. Additionally, or alternatively, where the respective monitoring window offset values for the configured set of BWPs may include respective second time offsets relative to the respective time gap values, where at least two BWPs of the plurality of BWPs associated with identical respective time gap values.

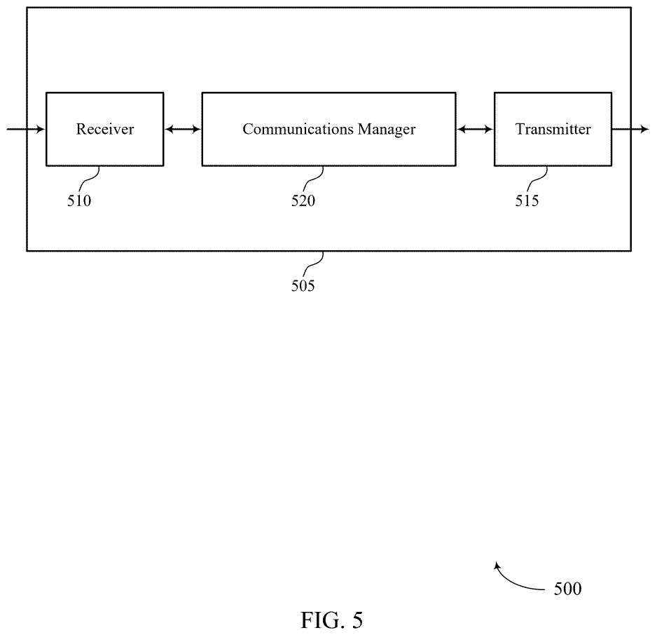

FIG. 5 shows a block diagram 500 of a device 505 that supports BWP-specific wake up signaling techniques for wireless communications in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to BWP-specific wake up signaling techniques for wireless communications). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to BWP-specific wake up signaling techniques for wireless communications). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of BWP-specific wake up signaling techniques for wireless communications as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving a configuration that indicates a set of multiple BWPs configured for communications by the UE. The communications manager 520 is capable of, configured to, or operable to support a means for receiving a WUS monitoring configuration that indicates different respective monitoring window offset values, different respective time gap values, or both for the set of multiple BWPs configured for communications by the UE, where the respective monitoring window offset values and respective time gap values correspond to boundaries of different respective WUS monitoring windows for the set of multiple BWPs. The communications manager 520 is capable of, configured to, or operable to support a means for monitoring, within each BWP of the set of multiple BWPs configured for communications by the UE, for wake-up signaling during one or more WUS monitoring occasions within the respective WUS monitoring window for the BWP.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for reduced processing, reduced power consumption due to utilization of WUS and power-saving BWP types, more efficient utilization of communication resources, more efficient utilization of BWP switching, reduced signaling overhead, and increased BWP configuration flexibility.

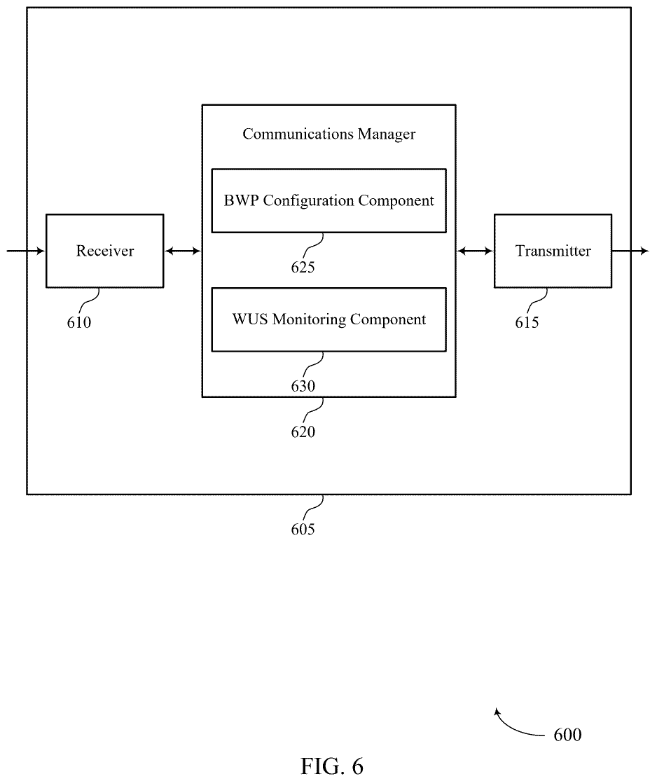

FIG. 6 shows a block diagram 600 of a device 605 that supports BWP-specific wake up signaling techniques for wireless communications in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to BWP-specific wake up signaling techniques for wireless communications). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to BWP-specific wake up signaling techniques for wireless communications). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of BWP-specific wake up signaling techniques for wireless communications as described herein. For example, the communications manager 620 may include a BWP configuration component 625 a WUS monitoring component 630, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The BWP configuration component 625 is capable of, configured to, or operable to support a means for receiving a configuration that indicates a set of multiple BWPs configured for communications by the UE. The WUS monitoring component 630 is capable of, configured to, or operable to support a means for receiving a WUS monitoring configuration that indicates different respective monitoring window offset values, different respective time gap values, or both for the set of multiple BWPs configured for communications by the UE, where the respective monitoring window offset values and respective time gap values correspond to boundaries of different respective WUS monitoring windows for the set of multiple BWPs. The WUS monitoring component 630 is capable of, configured to, or operable to support a means for monitoring, within each BWP of the set of multiple BWPs configured for communications by the UE, for wake-up signaling during one or more WUS monitoring occasions within the respective WUS monitoring window for the BWP.

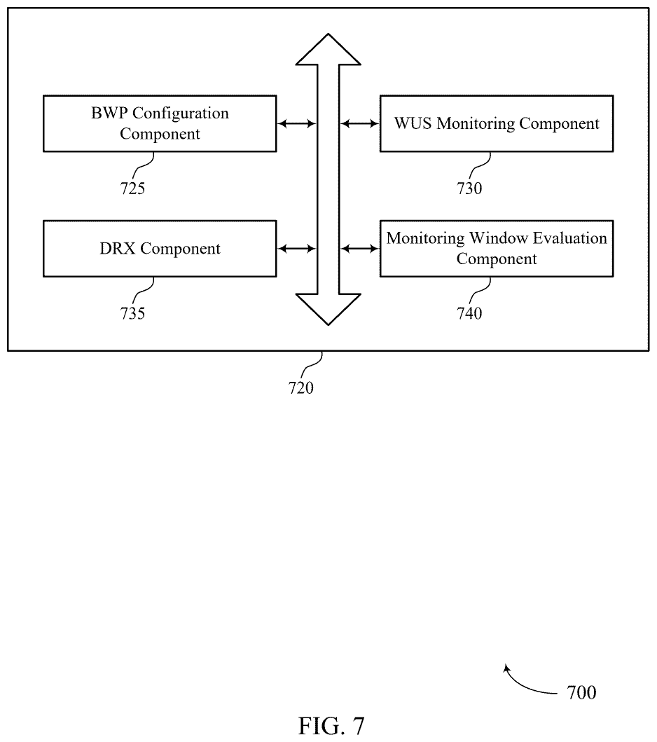

FIG. 7 shows a block diagram 700 of a communications manager 720 that supports BWP-specific wake up signaling techniques for wireless communications in accordance with one or more aspects of the present disclosure. The communications manager 720 may be an example of aspects of a communications manager 520, a communications manager 620, or both, as described herein. The communications manager 720, or various components thereof, may be an example of means for performing various aspects of BWP-specific wake up signaling techniques for wireless communications as described herein. For example, the communications manager 720 may include a BWP configuration component 725, a WUS monitoring component 730, a DRX component 735, a monitoring window evaluation component 740, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The BWP configuration component 725 is capable of, configured to, or operable to support a means for receiving a configuration that indicates a set of multiple BWPs configured for communications by the UE. The WUS monitoring component 730 is capable of, configured to, or operable to support a means for receiving a WUS monitoring configuration that indicates different respective monitoring window offset values, different respective time gap values, or both for the set of multiple BWPs configured for communications by the UE, where the respective monitoring window offset values and respective time gap values correspond to boundaries of different respective WUS monitoring windows for the set of multiple BWPs. In some examples, the WUS monitoring component 730 is capable of, configured to, or operable to support a means for monitoring, within each BWP of the set of multiple BWPs configured for communications by the UE, for wake-up signaling during one or more WUS monitoring occasions within the respective WUS monitoring window for the BWP.

In some examples, a respective time gap value for a BWP included in the set of multiple BWPs is a first time offset relative to a beginning of an ON duration of a discontinuous reception cycle for the BWP. In some examples, a respective monitoring window offset value for the BWP is a second time offset relative to the beginning of the ON duration of the discontinuous reception cycle for the BWP. In some examples, a respective WUS monitoring window for the BWP begins at a first time corresponding to the first time offset and ends at a second time corresponding to the second time offset.

In some examples, the WUS monitoring configuration indicates a first monitoring window offset value and a first time gap value for a first BWP of the set of multiple BWPs. In some examples, the WUS monitoring configuration indicates a second monitoring window offset value and a second time gap value for a second BWP of the set of multiple BWPs, where the second monitoring window offset value is different than the first monitoring window offset value, the second time gap value is different than the first time gap value, or both.

In some examples, the first BWP is a first type of BWP and the second BWP is a second type of BWP associated with higher power usage, higher throughput, lower latency, or any combination thereof relative to the first type of BWP. In some examples, the first monitoring window offset value, the first time gap value, or both are associated with the first type of BWP. In some examples, the second monitoring window offset value, the second time gap value, or both are associated with the second type of BWP.

In some examples, the monitoring window evaluation component 740 is capable of, configured to, or operable to support a means for transmitting a message that indicates a requested monitoring window offset value, a requested time gap value, or both for at least one BWP of the set of multiple BWPs configured for communications by the UE. In some examples, the message includes a UE assistance information message, a MAC-CE, an uplink control information message, or a UE capability message.

In some examples, the at least one BWP includes a first BWP of a first BWP type and a second BWP of a second BWP type associated with higher power usage, higher throughput, lower latency, or any combination thereof relative to the first BWP type. In some examples, the message indicates a first requested monitoring window offset value and a first requested time gap value corresponding to the first BWP type and a second requested monitoring window offset value and a second requested time gap value corresponding to the second BWP type.

In some examples, the set of multiple BWPs includes a first BWP and a second BWP, and the DRX component 735 is capable of, configured to, or operable to support a means for initiating, prior to an ON duration of a first discontinuous reception cycle for the first BWP, a first WUS monitoring window for the UE in accordance with a first monitoring window offset value associated with the first BWP. In some examples, the set of multiple BWPs includes a first BWP and a second BWP, and the DRX component 735 is capable of, configured to, or operable to support a means for switching, after the ON duration of the first discontinuous reception cycle for the first BWP, from monitoring the first BWP to monitoring the second BWP. In some examples, the set of multiple BWPs includes a first BWP and a second BWP, and the DRX component 735 is capable of, configured to, or operable to support a means for initiating, prior to an ON duration of a second discontinuous reception cycle for the second BWP, a second WUS monitoring window for the UE in accordance with a second monitoring window offset value associated with the second BWP, where initiation of the first WUS monitoring window precedes the ON duration of the first discontinuous reception cycle for the first BWP by a first time duration and initiation of the second WUS monitoring window precedes the ON duration of the second discontinuous reception cycle for the second BWP by a second time duration that is different than the first time duration in accordance with the second monitoring window offset value being different than the first monitoring window offset value.

In some examples, conclusion of the first WUS monitoring window precedes the ON duration of the first discontinuous reception cycle for the first BWP by a third time duration and conclusion of the second WUS monitoring window precedes the ON duration of the second discontinuous reception cycle for the second BWP by a fourth time duration that is different than the third time duration in accordance with a second time gap value associated with the second BWP being different than a first time gap value associated with the first BWP.

In some examples, the first WUS monitoring window is associated with a first energy expenditure by the UE that is different than a second energy expenditure by the UE associated with the second WUS monitoring window.

In some examples, the WUS monitoring component 730 is capable of, configured to, or operable to support a means for receiving, from a network entity, an indication of a respective range of allowed monitoring window offset values, a respective range of allowed time gap values, or both for each BWP of the set of multiple BWPs. In some examples, the monitoring window evaluation component 740 is capable of, configured to, or operable to support a means for transmitting a message that indicates a requested monitoring window offset value, a requested time gap value, or both for at least one BWP of the set of multiple BWPs configured for communications by the UE, where the requested monitoring window offset value falls within the respective range of allowed monitoring window offset values for the at least one BWP, the requested time gap value falls within the respective range of allowed time gap values for the at least one BWP, or both.

In some examples, the indication of the respective range of allowed monitoring window offset values includes an indication of a maximum allowable time offset relative to a default time gap value. In some examples, to support receiving the WUS monitoring configuration, the WUS monitoring component 730 is capable of, configured to, or operable to support a means for receiving the WUS monitoring configuration via RRC configuration signaling.

In some examples, the respective time gap values for the set of multiple BWPs include respective first time offsets relative to respective ON durations of respective discontinuous reception cycles for the set of multiple BWPs, at least two BWPs of the set of multiple BWPs associated with different respective time gap values. In some examples, the respective monitoring window offset values for the set of multiple BWPs include respective second time offsets relative to the respective time gap values, at least two BWPs of the set of multiple BWPs associated with identical respective time gap values.

In some examples, monitoring for the wake-up signaling within a BWP of the set of multiple BWPs includes monitoring, using a low-power radio, for one or more low-power wake-up signals during the one or more WUS monitoring occasions within the respective WUS monitoring window for the BWP. In some examples, the DRX component 735 is capable of, configured to, or operable to support a means for activating, at the UE, a main radio in accordance with detection of at least one of the one or more low-power wake-up signals.

In some examples, the one or more low-power wake-up signals include OOK-modulated symbols of an OFDM waveform. In some examples, the WUS monitoring configuration indicating the respective monitoring window offset values and the respective time gap values is associated with a traffic type associated with the UE, one or more capabilities of the UE, or both. In some examples, the wake-up signaling includes DCI signaling having a DCI format that is specific to the wake-up signaling.

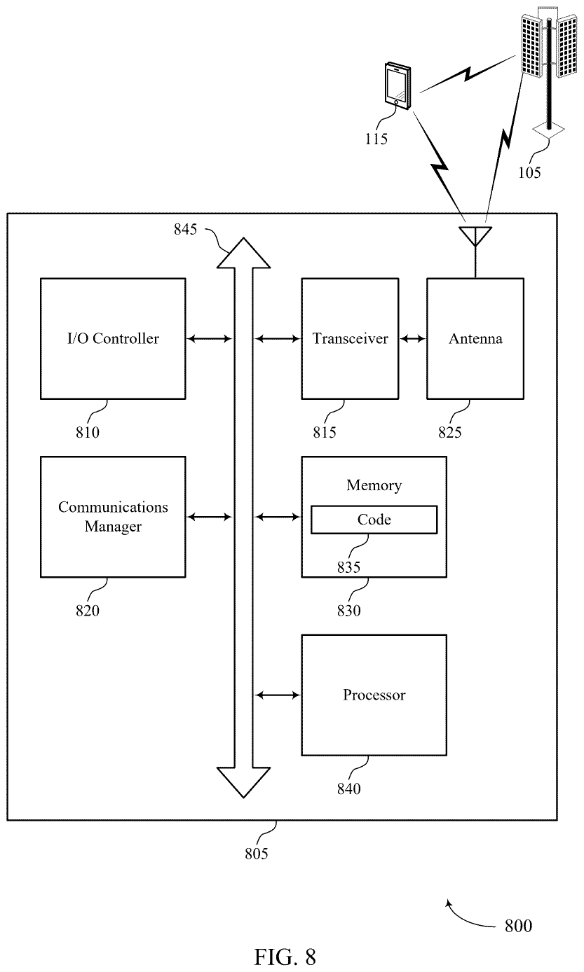

FIG. 8 shows a diagram of a system 800 including a device 805 that supports BWP-specific wake up signaling techniques for wireless communications in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting BWP-specific wake up signaling techniques for wireless communications). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving a configuration that indicates a set of multiple BWPs configured for communications by the UE. The communications manager 820 is capable of, configured to, or operable to support a means for receiving a WUS monitoring configuration that indicates different respective monitoring window offset values, different respective time gap values, or both for the set of multiple BWPs configured for communications by the UE, where the respective monitoring window offset values and respective time gap values correspond to boundaries of different respective WUS monitoring windows for the set of multiple BWPs. The communications manager 820 is capable of, configured to, or operable to support a means for monitoring, within each BWP of the set of multiple BWPs configured for communications by the UE, for wake-up signaling during one or more WUS monitoring occasions within the respective WUS monitoring window for the BWP.

By including or configuring the communications manager 820 in accordance with examples as described herein, the device 805 may support techniques for improved communication reliability, reduced latency, reduced power consumption, more efficient utilization of communication resources, improved coordination between devices, longer battery life, improved utilization of processing capability, reduced power consumption due to utilization of WUS and power-saving BWP types, more efficient utilization of BWP switching, reduced signaling overhead, and increased BWP configuration flexibility.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of BWP-specific wake up signaling techniques for wireless communications as described herein, or the at least one processor 840 and the at least one memory 830 may be otherwise configured to, individually or collectively, perform or support such operations.

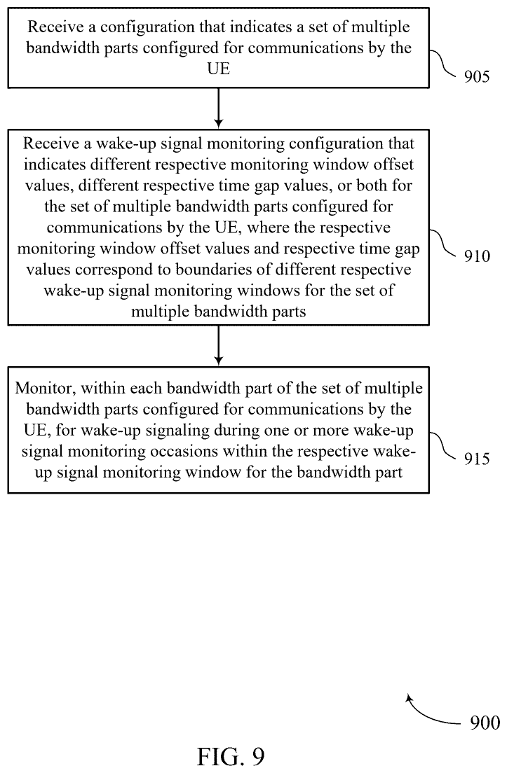

FIG. 9 shows a flowchart illustrating a method 900 that supports BWP-specific wake up signaling techniques for wireless communications in accordance with one or more aspects of the present disclosure. The operations of the method 900 may be implemented by a UE or its components as described herein. For example, the operations of the method 900 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 905, the method may include receiving a configuration that indicates a set of multiple BWPs configured for communications by the UE. The operations of 905 may be performed in accordance with examples as disclosed herein. In some examples, aspects of the operations of 905 may be performed by a BWP configuration component 725 as described with reference to FIG. 7.

At 910, the method may include receiving a WUS monitoring configuration that indicates different respective monitoring window offset values, different respective time gap values, or both for the set of multiple BWPs configured for communications by the UE, where the respective monitoring window offset values and respective time gap values correspond to boundaries of different respective WUS monitoring windows for the set of multiple BWPs. The operations of 910 may be performed in accordance with examples as disclosed herein. In some examples, aspects of the operations of 910 may be performed by a WUS monitoring component 730 as described with reference to FIG. 7.

At 915, the method may include monitoring, within each BWP of the set of multiple BWPs configured for communications by the UE, for wake-up signaling during one or more WUS monitoring occasions within the respective WUS monitoring window for the BWP. The operations of 915 may be performed in accordance with examples as disclosed herein. In some examples, aspects of the operations of 915 may be performed by a WUS monitoring component 730 as described with reference to FIG. 7.

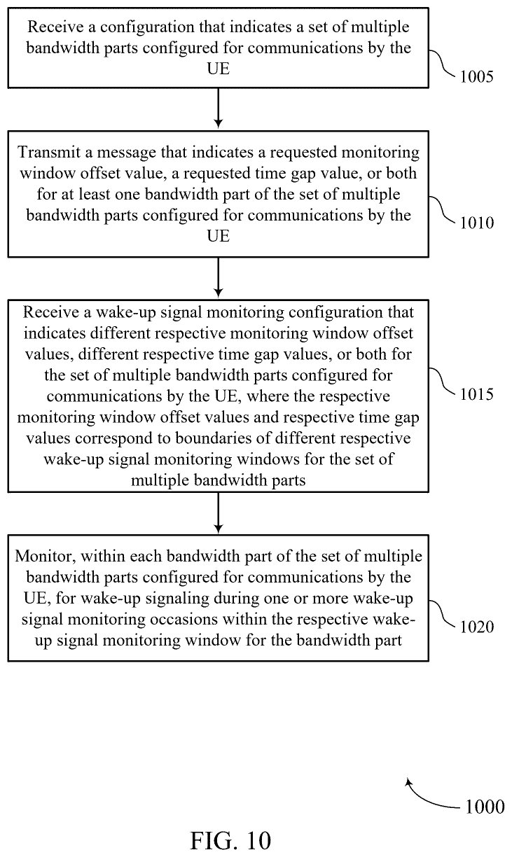

FIG. 10 shows a flowchart illustrating a method 1000 that supports BWP-specific wake up signaling techniques for wireless communications in accordance with one or more aspects of the present disclosure. The operations of the method 1000 may be implemented by a UE or its components as described herein. For example, the operations of the method 1000 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1005, the method may include receiving a configuration that indicates a set of multiple BWPs configured for communications by the UE. The operations of 1005 may be performed in accordance with examples as disclosed herein. In some examples, aspects of the operations of 1005 may be performed by a BWP configuration component 725 as described with reference to FIG. 7.

At 1010, the method may include transmitting a message that indicates a requested monitoring window offset value, a requested time gap value, or both for at least one BWP of the set of multiple BWPs configured for communications by the UE. The operations of 1010 may be performed in accordance with examples as disclosed herein. In some examples, aspects of the operations of 1010 may be performed by a monitoring window evaluation component 740 as described with reference to FIG. 7.

At 1015, the method may include receiving a WUS monitoring configuration that indicates different respective monitoring window offset values, different respective time gap values, or both for the set of multiple BWPs configured for communications by the UE, where the respective monitoring window offset values and respective time gap values correspond to boundaries of different respective WUS monitoring windows for the set of multiple BWPs. The operations of 1015 may be performed in accordance with examples as disclosed herein. In some examples, aspects of the operations of 1015 may be performed by a WUS monitoring component 730 as described with reference to FIG. 7.

At 1020, the method may include monitoring, within each BWP of the set of multiple BWPs configured for communications by the UE, for wake-up signaling during one or more WUS monitoring occasions within the respective WUS monitoring window for the BWP. The operations of 1020 may be performed in accordance with examples as disclosed herein. In some examples, aspects of the operations of 1020 may be performed by a WUS monitoring component 730 as described with reference to FIG. 7.

The following provides an overview of aspects of the present disclosure:

Aspect 1: A method for wireless communications at a UE, comprising: receiving a configuration that indicates a plurality of BWPs configured for communications by the UE; receiving a WUS monitoring configuration that indicates different respective monitoring window offset values, different respective time gap values, or both for the plurality of BWPs configured for communications by the UE, wherein the respective monitoring window offset values and respective time gap values correspond to boundaries of different respective WUS monitoring windows for the plurality of BWPs; and monitoring, within each BWP of the plurality of BWPs configured for communications by the UE, for wake-up signaling during one or more WUS monitoring occasions within the respective WUS monitoring window for the BWP.

Aspect 2: The method of aspect 1, wherein a respective time gap value for a BWP included in the plurality of BWPs comprises a first time offset relative to a beginning of an ON duration of a DRX cycle for the BWP; a respective monitoring window offset value for the BWP comprises a second time offset relative to the beginning of the ON duration of the DRX cycle for the BWP; and a respective WUS monitoring window for the BWP begins at a first time corresponding to the first time offset and ends at a second time corresponding to the second time offset.

Aspect 3: The method of any of aspects 1 through 2, wherein the WUS monitoring configuration indicates a first monitoring window offset value and a first time gap value for a first BWP of the plurality of BWPs; and a second monitoring window offset value and a second time gap value for a second BWP of the plurality of BWPs, wherein the second monitoring window offset value is different than the first monitoring window offset value, the second time gap value is different than the first time gap value, or both.

Aspect 4: The method of aspect 3, wherein the first BWP is a first type of BWP and the second BWP is a second type of BWP associated with higher power usage, higher throughput, lower latency, or any combination thereof relative to the first type of BWP, the first monitoring window offset value, the first time gap value, or both are associated with the first type of BWP, and the second monitoring window offset value, the second time gap value, or both are associated with the second type of BWP.

Aspect 5: The method of any of aspects 1 through 4, further comprising: transmitting a message that indicates a requested monitoring window offset value, a requested time gap value, or both for at least one BWP of the plurality of BWPs configured for communications by the UE.

Aspect 6: The method of aspect 5, wherein the message comprises a UE assistance information message, a medium access control-control element (MAC-CE), an uplink control information message, or a UE capability message.

Aspect 7: The method of any of aspects 5 through 6, wherein the at least one BWP comprises a first BWP of a first BWP type and a second BWP of a second BWP type associated with higher power usage, higher throughput, lower latency, or any combination thereof relative to the first BWP type; and the message indicates a first requested monitoring window offset value and a first requested time gap value corresponding to the first BWP type and a second requested monitoring window offset value and a second requested time gap value corresponding to the second BWP type.

Aspect 8: The method of any of aspects 1 through 7, wherein the plurality of BWPs comprises a first BWP and a second BWP, the method further comprising: initiating, prior to an ON duration of a first DRX cycle for the first BWP, a first WUS monitoring window for the UE in accordance with a first monitoring window offset value associated with the first BWP; switching, after the ON duration of the first DRX cycle for the first BWP, from monitoring the first BWP to monitoring the second BWP; and initiating, prior to an ON duration of a second DRX cycle for the second BWP, a second WUS monitoring window for the UE in accordance with a second monitoring window offset value associated with the second BWP, wherein initiation of the first WUS monitoring window precedes the ON duration of the first DRX cycle for the first BWP by a first time duration and initiation of the second WUS monitoring window precedes the ON duration of the second DRX cycle for the second BWP by a second time duration that is different than the first time duration in accordance with the second monitoring window offset value being different than the first monitoring window offset value.

Aspect 9: The method of aspect 8, wherein conclusion of the first WUS monitoring window precedes the ON duration of the first DRX cycle for the first BWP by a third time duration and conclusion of the second WUS monitoring window precedes the ON duration of the second DRX cycle for the second BWP by a fourth time duration that is different than the third time duration in accordance with a second time gap value associated with the second BWP being different than a first time gap value associated with the first BWP.

Aspect 10: The method of any of aspects 8 through 9, wherein the first WUS monitoring window is associated with a first energy expenditure by the UE that is different than a second energy expenditure by the UE associated with the second WUS monitoring window.

Aspect 11: The method of any of aspects 1 through 10, further comprising: receiving, from a network entity, an indication of a respective range of allowed monitoring window offset values, a respective range of allowed time gap values, or both for each BWP of the plurality of BWPs; and transmitting a message that indicates a requested monitoring window offset value, a requested time gap value, or both for at least one BWP of the plurality of BWPs configured for communications by the UE, wherein the requested monitoring window offset value falls within the respective range of allowed monitoring window offset values for the at least one BWP, the requested time gap value falls within the respective range of allowed time gap values for the at least one BWP, or both.

Aspect 12: The method of aspect 11, wherein the indication of the respective range of allowed monitoring window offset values comprises an indication of a maximum allowable time offset relative to a default time gap value.

Aspect 13: The method of any of aspects 1 through 12, wherein receiving the WUS monitoring configuration comprises: receiving the WUS monitoring configuration via RRC configuration signaling.

Aspect 14: The method of any of aspects 1 through 13, wherein the respective time gap values for the plurality of BWPs comprise respective first time offsets relative to respective ON durations of respective DRX cycles for the plurality of BWPs, at least two BWPs of the plurality of BWPs associated with different respective time gap values; and the respective monitoring window offset values for the plurality of BWPs comprise respective second time offsets relative to the respective time gap values, at least two BWPs of the plurality of BWPs associated with identical respective time gap values.

Aspect 15: The method of any of aspects 1 through 14, wherein monitoring for the wake-up signaling within a BWP of the plurality of BWPs comprises monitoring, using a low-power radio, for one or more low-power WUSs during the one or more WUS monitoring occasions within the respective WUS monitoring window for the BWP; and the method further comprises activating, at the UE, a main radio in accordance with detection of at least one of the one or more low-power WUSs.

Aspect 16: The method of aspect 15, wherein the one or more low-power WUSs comprise OOK modulated symbols of an OFDM waveform.

Aspect 17: The method of any of aspects 1 through 16, wherein the WUS monitoring configuration indicating the respective monitoring window offset values and the respective time gap values is associated with a traffic type associated with the UE, one or more capabilities of the UE, or both.

Aspect 18: The method of any of aspects 1 through 17, wherein the wake-up signaling comprises DCI signaling having a DCI format that is specific to the wake-up signaling.

Aspect 19: A UE for wireless communications, comprising one or more memories storing processor-executable code, and one or more processors coupled with the one or more memories and individually or collectively operable to execute the code to cause the UE to perform a method of any of aspects 1 through 18.

Aspect 20: A UE for wireless communications, comprising at least one means for performing a method of any of aspects 1 through 18.

Aspect 21: A non-transitory computer-readable medium storing code for wireless communications, the code comprising instructions executable by one or more processors to perform a method of any of aspects 1 through 18.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “a set,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive a configuration that indicates a plurality of bandwidth parts configured for communications by the UE;
receive a wake-up signal monitoring configuration that indicates different respective monitoring window offset values, different respective time gap values, or both for the plurality of bandwidth parts configured for communications by the UE, wherein the respective monitoring window offset values and respective time gap values correspond to boundaries of different respective wake-up signal monitoring windows for the plurality of bandwidth parts; and
monitor, within each bandwidth part of the plurality of bandwidth parts configured for communications by the UE, for wake-up signaling during one or more wake-up signal monitoring occasions within a respective wake-up signal monitoring window for a bandwidth part.

2. The UE of claim 1, wherein:
a respective time gap value for a bandwidth part included in the plurality of bandwidth parts comprises a first time offset relative to a beginning of an ON duration of a discontinuous reception cycle for the bandwidth part;
a respective monitoring window offset value for the bandwidth part comprises a second time offset relative to the beginning of the ON duration of the discontinuous reception cycle for the bandwidth part; and
the respective wake-up signal monitoring window for the bandwidth part begins at a first time corresponding to the first time offset and ends at a second time corresponding to the second time offset.

3. The UE of claim 1, wherein the wake-up signal monitoring configuration indicates:
a first monitoring window offset value and a first time gap value for a first bandwidth part of the plurality of bandwidth parts; and
a second monitoring window offset value and a second time gap value for a second bandwidth part of the plurality of bandwidth parts, wherein the second monitoring window offset value is different than the first monitoring window offset value, the second time gap value is different than the first time gap value, or both.

4. The UE of claim 3, wherein:
the first bandwidth part is a first type of bandwidth part and the second bandwidth part is a second type of bandwidth part associated with higher power usage, higher throughput, lower latency, or any combination thereof relative to the first type of bandwidth part;
the first monitoring window offset value, the first time gap value, or both are associated with the first type of bandwidth part; and
the second monitoring window offset value, the second time gap value, or both are associated with the second type of bandwidth part.

5. The UE of claim 1, wherein the one or more processors are individually or collectively further operable to execute the code to cause the UE to:
transmit a message that indicates a requested monitoring window offset value, a requested time gap value, or both for at least one bandwidth part of the plurality of bandwidth parts configured for communications by the UE.

6. The UE of claim 5, wherein the message comprises a UE assistance information message, a medium access control-control element (MAC-CE), an uplink control information message, or a UE capability message.

7. The UE of claim 5, wherein:
the at least one bandwidth part comprises a first bandwidth part of a first bandwidth part type and a second bandwidth part of a second bandwidth part type associated with higher power usage, higher throughput, lower latency, or any combination thereof relative to the first bandwidth part type; and
the message indicates a first requested monitoring window offset value and a first requested time gap value corresponding to the first bandwidth part type and a second requested monitoring window offset value and a second requested time gap value corresponding to the second bandwidth part type.

8. The UE of claim 1, wherein the plurality of bandwidth parts comprises a first bandwidth part and a second bandwidth part, and wherein the one or more processors are individually or collectively further operable to execute the code to cause the UE to:
initiate, prior to an ON duration of a first discontinuous reception cycle for the first bandwidth part, a first wake-up signal monitoring window for the UE in accordance with a first monitoring window offset value associated with the first bandwidth part;
switch, after the ON duration of the first discontinuous reception cycle for the first bandwidth part, from monitoring the first bandwidth part to monitoring the second bandwidth part; and
initiate, prior to an ON duration of a second discontinuous reception cycle for the second bandwidth part, a second wake-up signal monitoring window for the UE in accordance with a second monitoring window offset value associated with the second bandwidth part, wherein initiation of the first wake-up signal monitoring window precedes the ON duration of the first discontinuous reception cycle for the first bandwidth part by a first time duration and initiation of the second wake-up signal monitoring window precedes the ON duration of the second discontinuous reception cycle for the second bandwidth part by a second time duration that is different than the first time duration in accordance with the second monitoring window offset value being different than the first monitoring window offset value.

9. The UE of claim 8, wherein conclusion of the first wake-up signal monitoring window precedes the ON duration of the first discontinuous reception cycle for the first bandwidth part by a third time duration and conclusion of the second wake-up signal monitoring window precedes the ON duration of the second discontinuous reception cycle for the second bandwidth part by a fourth time duration that is different than the third time duration in accordance with a second time gap value associated with the second bandwidth part being different than a first time gap value associated with the first bandwidth part.

10. The UE of claim 8, wherein the first wake-up signal monitoring window is associated with a first energy expenditure by the UE that is different than a second energy expenditure by the UE associated with the second wake-up signal monitoring window.

11. The UE of claim 1, wherein the one or more processors are individually or collectively further operable to execute the code to cause the UE to:
receive, from a network entity, an indication of a respective range of allowed monitoring window offset values, a respective range of allowed time gap values, or both for each bandwidth part of the plurality of bandwidth parts; and
transmit a message that indicates a requested monitoring window offset value, a requested time gap value, or both for at least one bandwidth part of the plurality of bandwidth parts configured for communications by the UE, wherein the requested monitoring window offset value falls within the respective range of allowed monitoring window offset values for the at least one bandwidth part, the requested time gap value falls within the respective range of allowed time gap values for the at least one bandwidth part, or both.

12. The UE of claim 11, wherein the indication of the respective range of allowed monitoring window offset values comprises an indication of a maximum allowable time offset relative to a default time gap value.

13. The UE of claim 1, wherein, to receive the wake-up signal monitoring configuration, the one or more processors are individually or collectively operable to execute the code to cause the UE to:
receive the wake-up signal monitoring configuration via radio resource control (RRC) configuration signaling.

14. The UE of claim 1, wherein:
the respective time gap values for the plurality of bandwidth parts comprise respective first time offsets relative to respective ON durations of respective discontinuous reception cycles for the plurality of bandwidth parts, at least two bandwidth parts of the plurality of bandwidth parts associated with different respective time gap values; and
the respective monitoring window offset values for the plurality of bandwidth parts comprise respective second time offsets relative to the respective time gap values, at least two bandwidth parts of the plurality of bandwidth parts associated with identical respective time gap values.

15. The UE of claim 1, wherein:
to monitor for the wake-up signaling within a bandwidth part of the plurality of bandwidth parts, the one or more processors are individually or collectively operable to execute the code to cause the UE to monitor, using a low-power radio, for one or more low-power wake-up signals during the one or more wake-up signal monitoring occasions within the respective wake-up signal monitoring window for the bandwidth part; and
the one or more processors are individually or collectively further operable to execute the code to cause the UE to activate, at the UE, a main radio in accordance with detection of at least one of the one or more low-power wake-up signals.

16. The UE of claim 15, wherein the one or more low-power wake-up signals comprise on-off keying (OOK) modulated symbols of an orthogonal frequency division multiplexed (OFDM) waveform.

17. The UE of claim 1, wherein the wake-up signal monitoring configuration indicating the respective monitoring window offset values and the respective time gap values is associated with a traffic type associated with the UE, one or more capabilities of the UE, or both.

18. The UE of claim 1, wherein the wake-up signaling comprises downlink control information (DCI) signaling having a DCI format that is specific to the wake-up signaling.

19. A method for wireless communications at a user equipment (UE), comprising:
receiving a configuration that indicates a plurality of bandwidth parts configured for communications by the UE;
receiving a wake-up signal monitoring configuration that indicates different respective monitoring window offset values, different respective time gap values, or both for the plurality of bandwidth parts configured for communications by the UE, wherein the respective monitoring window offset values and respective time gap values correspond to boundaries of different respective wake-up signal monitoring windows for the plurality of bandwidth parts; and
monitoring, within each bandwidth part of the plurality of bandwidth parts configured for communications by the UE, for wake-up signaling during one or more wake-up signal monitoring occasions within a respective wake-up signal monitoring window for a bandwidth part.

20. A non-transitory computer-readable medium storing code for wireless communication, the code comprising instructions executable by one or more processors to:
receive a configuration that indicates a plurality of bandwidth parts configured for communications by a user equipment (UE);
receive a wake-up signal monitoring configuration that indicates different respective monitoring window offset values, different respective time gap values, or both for the plurality of bandwidth parts configured for communications by the UE, wherein the respective monitoring window offset values and respective time gap values correspond to boundaries of different respective wake-up signal monitoring windows for the plurality of bandwidth parts; and
monitor, within each bandwidth part of the plurality of bandwidth parts configured for communications by the UE, for wake-up signaling during one or more wake-up signal monitoring occasions within a respective wake-up signal monitoring window for a bandwidth part.
